(19) United States
(12) Patent Application Publication
(10) Pub. No.: US 2026/0225360 A1
(43) Pub. Date: Aug. 6, 2026

(54) METHOD FOR PRODUCING SUBSTRATE STACKS FOR FURTHER PROCESSING INTO COMPOSITE SHEETS FOR OPTICAL LIGHT GUIDE ELEMENTS

(71) Applicant: SCHOTT AG, Mainz (DE)

(72) Inventors: Stefan WEIDLICH, Mainz (DE); Yakup GÖNÜLLÜ, Mainz (DE); Hauke ESEMANN, Mainz (DE); Fangtong XIE, Mainz (DE); Frederik BACHHUBER, Mainz (DE)

(21) Appl. No.: 19/152,315

(22) PCT Filed: Mar. 28, 2024
(86) PCT No.: PCT/EP2024/058514

§ 371 Date: Jul. 30, 2025

(30) Foreign Application Priority Data
Mar. 29, 2023 (DE) 10 2023 108 065.2

(51) Int. Cl. B32B 37/12; B32B 7/12; B32B 17/06; B32B 38/00

(52) U.S. Cl. CPC B32B 37/12; B32B 7/12; B32B 17/06; B32B 38/0004; B32B 38/0012; B32B 2307/418; B32B 2307/7376; B32B 2551/00

(57) ABSTRACT

A method for producing a stack for further processing into composite sheets, the method comprising bonding two or more sheet-like substrates with an adhesive layer; also to a method for producing a composite sheet and to a composite sheet, preferably for use as an optical light guide element or in an optical light guide element, in particular for use in the field of augmented reality are disclosed.

The present invention relates to a method for producing a stack for further processing into composite sheets, comprising bonding two or more planar substrates with a layer of adhesive, and to a composite sheet and to a method for producing a composite sheet, preferably for use as or in an optical waveguide element, in particular for use in the field of augmented reality.

Waveguide elements perform a central function in imaging optical systems for augmented reality applications. Such imaging optical systems in the area of augmented reality may be, for example, wearable head-mounted systems in which a user is additionally presented with an image in their field of view. The additional image is able to display additional information to the user in a variety of ways, for instance in order to display invisible elements to a surgeon in medicine, said elements having been previously recorded by tomography for example. Other applications relate to navigation, for example in aircraft or vehicles. Here, diffractive or reflective optical elements may be used.

Such imaging optical systems may comprise an eyepiece in order to visualize projected images thereon for the user. The eyepieces may comprise highly thin, preferably high-refractive optical glasses or a composite comprising corresponding highly thin optical materials, for example glasses.

Waveguide elements, especially when using a composite of multiple thin optical materials or substrates, must have high requirements, in particular with respect to the internal quality of the substrates or wafers integrated therein, and a precisely set geometry of the individual substrates and the waveguide elements produced therefrom. Such waveguide elements typically comprise a multiplicity of coated and/or uncoated substrates bonded to each other by an adhesive. From the stack obtained, waveguide elements are then obtained by singulation steps. Especially for the use of substrates for such composite components comprising a multiplicity of such substrates, it is highly important that the individual substrates meet strict requirements with respect to the aforementioned quality factors. Otherwise, there is the risk of geometric differences in the individual substrates adding up in the waveguide elements produced therefrom, resulting in inadequate imaging quality. Here, it is furthermore also necessary to take into account the contributions of the numerous layers of adhesive in such a composite when checking the geometry and optical properties of the composite.

It is therefore an object of the present invention to provide a method for producing a stack for further processing into an optical waveguide element having outstanding properties of the stack and the waveguide element with respect to geometry and to internal quality and to surface quality. It is also an object of the invention to provide an optical waveguide element having outstanding optical properties.

The object is achieved by the subject matter of the claims.

This object is achieved in particular by a method for producing a stack for further processing into composite sheets, comprising bonding two or more planar substrates with a layer of adhesive, the planar substrates each having a first and a second surface that are parallel to each other, comprising the steps of:
a) providing a first planar substrate, at least the first surface of the first planar substrate being optionally pretreated by cleaning, plasma treatment and/or applying an adhesion promoter,
b) applying an adhesive having a first viscosity to the first surface of the first substrate and rotating the first substrate, the adhesive being distributed on the first surface of the first substrate, and the resultant layer of adhesive having a layer thickness of from 0.2 μm to 5.0 μm,
c) optionally varying the viscosity of the adhesive by heating or cooling,
d) bonding the first planar substrate to a second planar substrate to form a first stack, comprising contacting the first surface of the first substrate with the second surface of the second substrate and curing the layer of adhesive.

“Parallel” in the context of the present invention means that two surfaces each independently have a parallelism of not more than 280 arcsec, preferably not more than 250 arcsec, preferably not more than 200 arcsec or not more than 180 arcsec, preferably not more than 150 arcsec, preferably not more than 120 arcsec, in both spatial directions. The parallelism is preferably determined as follows:
1. A surface is approximated by regression of a mathematically perfect two-dimensional plane in such a way that the deviations of the real topography of the surface from the regression plane are minimized in both spatial directions.
2. A further surface is approximated by regression of a mathematically perfect two-dimensional plane in such a way that the deviations of the real topography of the further surface from the regression plane are minimized in both spatial directions.
3. The angle between the two mathematically perfect planes is then determined for both spatial directions.

Preferably, the first and the first surface of the planar substrates each independently have a parallelism of not more than 90 arcsec, preferably not more than 60 arcsec or not more than 50 arcsec, further preferably not more than 40 arcsec or not more than 30 arcsec, particularly preferably not more than 20 arcsec, for both spatial directions. This applies irrespective of whether the first and/or the second surface have been provided with an inorganic coating.

Preferably, the first and the first surface of the stack according to the invention each independently have a parallelism of not more than 120 arcsec, preferably not more than 110 arcsec or not more than 100 arcsec, further preferably not more than 90 arcsec or not more than 80 arcsec, particularly preferably not more than 60 arcsec or not more than 50 arcsec, likewise preferably not more than 40 arcsec or not more than 30 arcsec, for both spatial directions. This applies irrespective of whether the first and/or the second surface have been provided with an inorganic coating.

The parallelism of the surfaces of the planar substrates or the stack may be determined, for example, in the volume of the stack with an autocollimator. Preference is given to determining the parallelism at the edges of the stack by a videometric or optical measurement, for example with a coordinate-measuring machine, for example with a Zeiss O-Inspect multi-sensor measuring machine from Carl Zeiss AG.

In the method according to the invention, two or more planar substrates, also referred to hereinafter as “substrates”, are bonded together, yielding a stack comprising at least two planar substrates.

Planar substrates according to the present invention each have a first and a second surface that are parallel to each other. The first and the second surface of a substrate are the so-called “main surfaces”. It is clear to a person skilled in the art that the planar substrates also comprise at least one lateral surface. The distance from the first to the second surface of the substrate is also referred to hereinafter as the thickness of the substrate. Preferably, the planar substrates have a thickness of from 0.2 mm to 2.0 mm, preferably from 0.3 mm to 1.8 mm, preferably from 0.4 to 1.7 mm and particularly preferably from 0.5 to 1.5 mm.

The planar substrates are preferably round or angular, preferably angular, particularly preferably rectangular or square.

If the planar substrates are angular substrates, they have a length and/or width of from 10 mm to 300 mm, preferably from 20 mm to 150 mm, further preferably from 30 mm to 100 mm, for example from 50 mm to 80 mm.

Round planar substrates preferably have a diameter of from 10 mm to 300 mm, preferably from 15 mm to 200 mm, preferably from 20 mm to 150 mm, further preferably from 30 mm to 100 mm, for example from 50 mm to 80 mm.

The thicknesses of the planar substrates in a stack may be different or identical.

Preferably, the planar substrates comprise or consist of a glass, a glass ceramic, an optical ceramic or a plastic, preferably a glass and/or a plastic, particularly preferably a glass. Preferably, the planar substrates consist of a glass or a plastic, particularly preferably a glass. Preference is given to a glass having a refractive index n_{d} in the range from 1.45 to 2.30, preferably from 1.47 to 2.10, preferably from 1.50 is 2.00, likewise preferably from 1.47 to 1.8.

Preferably, the planar substrates comprise a material transparent at least for a wavelength in the range from 450 nm to 650 nm, preferably transparent for all wavelengths in the range from 450 nm to 650 nm.

In some embodiments, the stack produced according to the invention comprises planar substrates made of different materials, but preferably all planar substrates in a stack produced according to the invention comprise the same material, and preferably all planar substrates in a stack produced according to the invention consist of the same material.

In embodiments in which at least one planar substrate comprises or consists of a glass, the glass is preferably a silicate glass, for example a barium-containing silicate glass. For example, the substrate may comprise or consist of a flint glass or crown glass. Optionally, the glass is selected from an alkaline earth metal-containing flint glass, a barium flint glass, a barium crown glass, a boron-containing crown glass, a lanthanum flint glass, a lanthanum crown glass and combinations thereof.

Preferably, the planar substrates meet at least one of the following conditions:
i) a total thickness variation of less than 10 μm;
ii) bow<100 μm;
iii) warp<100 μm;
iv) roughness R_{q}≤5 nm.

The planar substrates may be uncoated or may have an inorganic coating on one or two surfaces.

Preferably, at least 50%, preferably at least 60% or at least 70%, preferably at least 80%, particularly preferably at least 90% or 100% of the planar substrates in the stack produced according to the invention meet at least one of conditions i) to iv), preferably at least two of conditions i) to iv), preferably at least three of conditions i) to iv) and particularly preferably all of conditions i) to iv).

Preferably, the planar substrates have a total thickness variation, also referred to hereinafter as “TTV”, of less than 10 μm, preferably less than 8 μm, preferably less than 5 μm, preferably less than 4 μm, further preferably less than 3 μm, particularly preferably less than 2 μm or less than 1 μm, further particularly preferably less than 0.75 μm, likewise particularly preferably less than 0.5 μm. The total thickness variation may be determined, for example, according to SEMI MF 1530GBIR. The total thickness variation may also be determined by interferometric measurements of the thickness profile of the planar substrates, for example with an interferometer, in particular an interferometer from Zygo Corporation. In some embodiments, the planar substrates have a TTV of at least 0.1 μm or at least 0.2 μm. Planar substrates having a low TTV are particularly advantageous for the use of the produced stacks, or the waveguide elements manufactured therefrom, in augmented reality applications. Planar substrates having a low TTV may be produced, for example, by suitable abrasive methods such as grinding, lapping and/or polishing and/or by ion-beam processing as described in German patent application DE 10 2021 125 476.

Preferably, the first and/or the second surfaces, preferably the first and the second surfaces, of the planar substrates for producing the stack according to the invention have a roughness R_{q} of from 0.1 nm to 5 nm, preferably not more than 5 nm, preferably less than 5 nm, preferably less than 4 nm or less than 3 nm, further preferably less than 2 nm or less than 1.5 nm or particularly preferably less than 1 nm or less than 0.5 nm.

The roughness R_{q} in this context means the quadratic mean roughness, also known as RMS (“root mean square”), and can be measured, for example, by means of white light interferometers or AFM technology, preferably in accordance with DIN EN ISO 4287.

Preferably, the planar substrates for producing a stack in accordance with the invention have a warp of more than 1 μm, more than 5 μm or more than 10 μm, and/or less than 100 μm, preferably less than 50 μm, further preferably less than 20 μm, and/or a bow of more than 1 μm, more than 5 μm or more than 10 μm, and/or less than 100 μm, preferably less than 50 μm, further preferably less than 20 μm. Preferably, the planar substrates have a bow and/or a warp of less than 0.1%, preferably less than 0.075%, preferably less than 0.05% and preferably less than 0.01% of the substrate diameter. Preferably, warp and bow are determined according to SEMI3D1203152015.

Warp and bow are characteristics used for expressing the shape of a planar substrate that is resting and is therefore not held by a chuck for example. The substrate is therefore supported without any forces or is resting on a flat base. The median surface in the thickness direction of the substrate acts as the measurement plane, with the best-fitting plane being assumed as a reference plane for the measurement plane. Warp is the maximum value of the offset from the reference plane to the measurement plane. Bow is the difference between the reference plane and the measurement plane at the center of the substrate. If the substrate is supported by a localized support, for example in the case of a 3-point support or fork support in the edge region, the influence of gravitational forces also results in additional bends, which are referred to as sagging. The form of these bends thus substantially depends on the geometric arrangement of the support. Furthermore, the mechanical properties of the material and the geometric shape of the substrate are parameters that determine sagging.

In a first step a) of the method according to the invention, a first planar substrate, also referred to hereinafter as “first substrate”, comprising a first and a second surface, the first and the second surface being parallel to each other, is provided.

In some embodiments, at least the first surface of the first planar substrate is pretreated by cleaning, plasma treatment and/or applying an adhesion promoter. A person skilled in the art will choose the type of pretreatment depending on the material from which the first planar substrate has been formed.

In advantageous embodiments of the method according to the invention, cleaning is carried out of at least the first surface of the first substrate and/or the second surface of the first substrate, in particular wet-chemical cleaning, for example with distilled or deionized water, with an aqueous solution of an acid, with an aqueous solution of a base or with an organic solvent, preferably with distilled or deionized water.

In advantageous embodiments of the method according to the invention, plasma treatment is carried out of at least the first surface of the substrate, preferably after cleaning of the first and optionally the second surface of the first substrate. As a result, the first and optionally the second surface of the first substrate—optionally after wet-chemical cleaning—can be cleaned and/or modified and thereby activated, with preferably the wettability of the first surface being increased.

In advantageous embodiments of the method according to the invention, an adhesion promoter is applied to the first surface of the first substrate, preferably after cleaning of the first and optionally the second surface of the first substrate and/or after plasma treatment of the first surface and optionally the second surface of the first substrate.

Such adhesion promoters, also referred to hereinafter as “primer”, serve to act as an adhesive bridge between the first substrate and the adhesive and to thereby improve adhesion.

Preferably, the adhesion promoter is a silane adhesion promoter, preferably of the general formula R—SiX₃, where R is preferably an organically functionalized radical and X is preferably a hydrolyzable group, for example an alkoxy group. A person skilled in the art will select suitable adhesion promoters depending on the adhesive used.

Preferably, the adhesion promoter is applied to the first surface of the first planar substrate as a monolayer and/or preferably with a layer thickness of less than 20 nm, preferably less than 15 nm, further preferably less than 10 nm, further preferably less than 5 nm, less than 3 nm and likewise preferably less than 1 nm.

In step b) of the method according to the invention, an adhesive is applied to the—optionally pretreated—first surface of the first planar substrate and is distributed on the first surface of the first substrate by rotating the substrate.

This method is also referred to hereinafter as “spin coating”.

To this end, the first substrate is preferably placed on a rotatable substrate carrier (also called a “spin chuck”). The adhesive is applied to the first surface of the first substrate near the center, i.e., near the axis of rotation. The so-called “centrifugation” of the excess adhesive produces a thin film, i.e., a layer of adhesive, on the first surface of the first substrate. The layer thickness of the adhesive film produced is produced by the viscosity of the adhesive and the number of revolutions in spin coating. Typically, spin coating is carried out at a speed of up to 9000 rpm (“rounds per minute”). In an advantageous embodiment, spin coating is carried out at room temperature. In some embodiments, spin coating is carried out at a temperature higher than room temperature, preferably at a temperature of at least 30° C., at least 40° C., at least 50° C., at least 60° C., at least 70° C., at least 80° C., at least 90° C. or at least 100° C. This can be especially advantageous if the adhesive has an insufficiently low viscosity at room temperature. Preferably, spin coating is carried out at room temperature and/or under cleanroom conditions.

Preferably, a layer of adhesive is formed at least on part of the first surface, preferably on the entire first surface, of the first substrate. The layer of adhesive has a thickness of from 0.2 μm to 5.0 μm, preferably from 0.5 μm to 4.5 μm, preferably from 1.0 μm to 4.0 μm, preferably from 1.5 μm to 3.5 μm, particularly preferably from 2.0 μm to 3.0 μm. The layer of adhesive has a homogeneous thickness over the entire adhesive-covered region of the first surface of the first substrate.

Preferably, the layer of adhesive meets at least one of the following conditions:
v) a total thickness variation (TTV) of less than 20 μm;
vi) no inclusions having a particle size greater than the thickness of the layer of adhesive;
vii) a refractive index n_{d} which differs not more than 0.005, preferably not more than 0.004, preferably not more than 0.003, or not more than 0.002, particularly preferably not more than 0.001, from the refractive index n_{d} of the planar substrates.

According to the invention, the layer of adhesive has a total thickness variation, also referred to hereinafter as “TTV”, of less than 20 μm, preferably less than 15 μm, further preferably less than 12 μm, further preferably less than 10 μm, likewise preferably less than 7 μm, preferably less than 5 μm, preferably less than 4 μm or less than 3 μm, preferably less than 2.5 μm or less than 2 μm, preferably less than 1.5 μm or less than 1 μm, particularly preferably less than 0.75 μm, further preferably less than 0.5 μm, further particularly preferably less than 0.3 μm or 0.2 μm. The above explanations concerning the significance of determining TTV apply analogously here.

Preferably, the adhesive does not comprise any inclusions having a particle size greater than the thickness of the layer of adhesive. Inclusions in the context of the present invention are, for example, impurities and bubbles, for example air bubbles.

The term “adhesive” in the context of the present invention encompasses both solvent-free adhesive and adhesive solutions. Whenever “adhesive” is mentioned hereinafter, this encompasses both solvent-free adhesives and adhesive solutions. Suitable adhesives include acrylate adhesives, epoxy adhesives, silicone adhesives, polyurethane adhesives, acrylate adhesives filled with nanoparticles, epoxy adhesives filled with nanoparticles, silicone adhesives filled with nanoparticles or polyurethane adhesives filled with nanoparticles, sol-gel adhesive systems. Preferably, the adhesive is an acrylate adhesive, an epoxy adhesive, a silicone adhesive or a polyurethane adhesive, or solutions thereof, particularly preferably an acrylate adhesive or solutions thereof.

The adhesive may be a light-curing adhesive, a heat-curing adhesive or an anaerobically curing adhesive. Preference is given to a light-curing adhesive, preferably a UV-curing adhesive. Preferably, the adhesive is a light-curing, preferably UV-curing, acrylate adhesive.

Preferably, the adhesive has a refractive index n_{d} which differs not more than 0.005, preferably not more than 0.004, preferably not more than 0.003, or not more than 0.002, particularly preferably not more than 0.001, from the refractive index n_{d} of the planar substrates.

Light-curing adhesives cure by irradiation with light of a suitable wavelength. Preference is given to a UV-curing adhesive. Such UV-curing adhesives cure by irradiation with UV light. UV-curing adhesives suitable for the method according to the invention preferably cure at room temperature. Preferably, the UV-curing adhesive is a relatively optically clear adhesive which preferably has a refractive index n_{d} substantially corresponding to the refractive index n_{d} of the planar substrates and which preferably exhibits low shrinkage on curing. This can avoid or at least minimize stresses in the stack produced according to the invention.

According to the invention, an adhesive having a first viscosity is applied to the first surface of the first substrate. A person skilled in the art will select an adhesive having a viscosity sufficiently low to ensure a homogeneous distribution of the adhesive on the first surface of the first substrate during the spin coating process.

Preferably, the adhesive has a first viscosity of not more than 1500 mPas, preferably not more than 1000 mPas or not more than 900 mPas, preferably not more than 800 mPas or not more than 700 mPas, further preferably not more than 600 mPas or 500 mPas, particularly preferably not more than 400 mPas and/or at least 20 mPas, preferably at least 25 mPas, preferably at least 50 mPas, further preferably at least 100 mPas. If the adhesive has an excessively high viscosity, it may be preferably used as an adhesive solution having a first viscosity within the aforementioned ranges. Solvents for producing adhesive solutions are in particular organic solvents, in particular ethers or alcohols, for example isobutyl alcohol or tetrahydrofurfuryl.

Preferably, the adhesive is applied to the center of the first surface of the first substrate.

Optionally, the method according to the invention comprises a step c), wherein the viscosity of the adhesive is varied by heating or cooling. In one embodiment of the method according to the invention, step c) is carried out while the adhesive is being distributed on the first surface of the first substrate by rotating the first substrate. Here, for example, the viscosity of the adhesive may be reduced in order to achieve an optimal distribution on the first surface or to control the thickness of the resultant layer of adhesive. Alternatively or additionally, the viscosity is varied after ending the rotation of the applied adhesive or the applied layer of adhesive, after the rotation of the first substrate is ended. Preferably, step c) of the method according to the invention comprises heating or cooling. In one advantageous embodiment, if the spin coating process is carried out at temperatures higher than room temperature, the viscosity of the adhesive is varied, in particular increased, by cooling to room temperature for example. In another embodiment, the first surface of the first substrate provided with a layer of adhesive is preferably heated. This heating step is also called “softbaking”. Here, the temperature chosen is one that achieves a sufficient increase in the viscosity of the layer of adhesive. If the adhesive is an adhesive solution, softbaking is carried out at a temperature sufficiently high to remove the solvent. Depending on the solvent in the adhesive solution applied to the first surface of the first substrate, softbaking may be carried out at a temperature higher than 50° C. and/or not higher than 300° C., not higher than 150° C., preferably not higher than 120° C.

According to the invention, the method comprises step d), wherein the first planar substrate provided with a layer of adhesive is bonded to a second planar substrate to form a first stack, comprising contacting the first surface of the first substrate with the second surface of the second substrate and curing the layer of adhesive.

It will be understood that the second surface of the second substrate is contacted here with the layer of adhesive on the first surface of the first substrate.

Preferably, the first substrate and the second substrate are bonded to each other over the surface or full surface thereof by a layer of adhesive.

Typically, the first substrate is bonded to the second substrate at room temperature and/or under application of pressure, preferably of less than 5 MPa, preferably less than 3 MPa, further preferably less than 2 MPa and particularly preferably less than 1 MPa.

The layer of adhesive is cured according to the adhesive used, for example by irradiation with light, in particular UV light, for example with a wavelength of 400 nm.

After the layer of adhesive has been cured, a first stack comprising a first planar substrate and a second planar substrate bonded to each other by a layer of adhesive is obtained. Thereafter, a further step in which the first stack is heated may be carried out. This can be used in particular to increase the strength of the bond due to the layer of adhesive, for example through stronger crosslinking in the layer of adhesive. This step is also called “hardbaking”.

Preferably, the method according to the invention comprises bonding the first stack to a third planar substrate (also referred to hereinafter as “third substrate”), comprising the following steps:
a1) providing a third planar substrate, at least the first surface of the third planar substrate being optionally pretreated by cleaning, plasma treatment and/or applying an adhesion promoter,
b1) applying an adhesive having a first viscosity to the first surface of the third substrate and rotating the third substrate, the adhesive being distributed on the first surface of the third substrate, and the resultant layer of adhesive having a layer thickness of from 0.2 μm to 5.0,
c1) optionally varying the viscosity of the adhesive by heating or cooling,
d1) bonding the third planar substrate to the first stack, comprising contacting the first surface of the third substrate with a surface of the first stack and curing the layer of adhesive, a second stack being obtained.

After the layer of adhesive has been cured, a second stack comprising a first, a second and a third planar substrate, the first and the second substrate being bonded by a layer of adhesive and the second and the third substrate being bonded by a layer of adhesive, is obtained.

Preferably, the method according to the invention comprises bonding the second stack to a further planar substrate (also referred to hereinafter as “further substrate”), the abovementioned steps a1) to d1) being repeated for this purpose, the second stack being used as first stack and a further stack being obtained. This results in a further stack comprising four planar substrates bonded by three layers of adhesive.

This may be repeated as often as desired until the desired stack comprising 2 to 50, preferably 4 to 45, further preferably 6 to 35 or 6 to 30, particularly preferably 8 to 25 or 8 to 20 planar substrates is obtained, a further substrate being subjected to steps a1), b1) and c1) each time and subsequently bonded in step d1) to an existing further stack used as first stack.

The preferred embodiments and explanations in connection with producing the first stack apply mutatis mutandis to the production of the second stack and each further stack.

Especially in embodiments in which the stack produced according to the invention comprises a comparatively large number of planar substrates, it may be advantageous to first produce a number of further stacks by the method according to the invention and then adhesively bond them to each other.

Preferably, the stack produced according to the invention comprises at least one planar substrate having an inorganic coating on the first and/or the second surface.

The inorganic coating may comprise one or more layers; preferably, the coating comprises at least 2 layers. Preferably, the inorganic coating comprises 2 to 100 layers, preferably 4 to 50 layers, preferably 5 to 40 layers, particularly preferably 7 to 35 layers.

Preferably, the inorganic coating comprises one or more components selected from one or more oxides, one or more fluorides, one or more nitrides, one or more sulfides, one or more selenides, one or more metals and combinations of two or more thereof. For example, the inorganic coating comprises or consists of one or more components selected from one or more metal oxides, one or more metal fluorides, one or more metal nitrides, one or more metal sulfides, one or more metal selenides and combinations of two or more thereof. Oxides according to the present invention are preferably selected from silicon oxide, aluminum oxide, hafnium oxide, tantalum oxide, niobium oxide, titanium oxide, zirconium oxide, yttrium oxide, praseodymium oxide, scandium oxide, tin oxide, chromium oxide, indium oxide and combinations of two or more thereof. In some embodiments, combinations of two or more oxides comprise mixed oxides.

Fluorides in the context of the invention are preferably selected from aluminum fluoride, magnesium fluoride, neodymium fluoride, lanthanum fluoride, yttrium fluoride, gadolinium fluoride, ytterbium fluoride and combinations of two or more thereof.

Nitrides in the context of the present invention are preferably selected from aluminum nitride, silicon nitride and combinations thereof. Sulfides in the context of the present invention are, for example, zinc sulfide. Selenides in the context of the present invention are, for example, zinc selenides. Metals in the context of the present invention are preferably selected from aluminum, silver, gold, chromium, nickel and combinations thereof. Optionally, the combination of two or more metals is an alloy. Preferably, the metallic layer has a thickness of not more than 10 nm in order to ensure sufficient transparency.

In one advantageous embodiment, the inorganic coating comprises at least one dielectric layer; preferably, all the layers of the inorganic coating are dielectric layers.

In another advantageous embodiment, the inorganic coating comprises at least one metallic layer consisting of or comprising at least one metal, for example Ag, the at least one metallic layer having a thickness of not more than 10 nm.

Preferably, the inorganic coating has a thickness of from 200 nm to 2000 nm, preferably from 300 nm to 1900 nm, further preferably from 400 nm to 1800 nm or 500 to 1700 nm, particularly preferably from 600 nm to 1600 nm.

In preferred embodiments, the inorganic coating is a multilayer coating comprising two or more layers, the respective layers having a thickness of from 1 nm to 200 nm, from 4 to 100 nm, from 8 nm to 800 nm, from 10 nm to 700 nm, from 15 nm to 600 nm or from 15 nm to 500 nm.

Preferably, the inorganic coating has a refractive index of from 1.45 to 3.00, from 1.47 to 2.50, from 1.50 to 2.00 or from 1.51 to 1.90 or from 1.60 to 1.90.

In advantageous embodiments, the inorganic coating has a refractive index corresponding to the refractive index of the substrate. Preferably, the ratio of the refractive index of the substrate to the refractive index of the inorganic coating is between 0.9 and 1.1, preferably between 0.95 and 1.05, further preferably between 0.98 and 1.03.

Preferably, the refractive index of the inorganic coating is the mean refractive index of the coating.

For example, the following formula may be used to determine the mean refractive index n of the coating for a total thickness of the coating, where the local refractive index of the coating/its layers is n(x):

$$\overline{n} = {\int }_{0}^{d} n ( x ) dx / {\int }_{0}^{d} dx .$$

The stack produced according to the invention has a first and a second surface and at least one interface. Interface in the context of the present invention means the surface between two planar substrates and may comprise a layer of adhesive and preferably one or two inorganic coatings due to the production process. Preferably, the interface between two planar substrates comprises a layer of adhesive and an inorganic coating.

Preferably, the stack produced according to the invention comprises an alternating arrangement—and without taking into account the layers of adhesive—of planar substrates and inorganic coatings.

Preferably, the stack according to the invention comprises an alternating arrangement—and without taking into account the layers of adhesive—of a planar substrate(S) and an inorganic coating (B), the combination (S-B) being repeated x times. In other words, the stack comprises (S-B)ₓ. In this embodiment, the first or the second surface of the stack is uncoated. In some embodiments, the stack comprises the sequence (S-B)ₓ-S. In these embodiments, the first and the second surface of the stack are uncoated. In some embodiments, the stack comprises the sequence B-(S-B)ₓ. In these embodiments, the first and the second surface of the stack are coated.

In one embodiment, stacks according to the invention comprising an alternating arrangement of a planar substrate and an inorganic coating are preferably produced by bonding multiple planar substrates, each of which has an inorganic coating on a first or a second surface.

In another embodiment, producing a stack according to the invention comprises alternatingly bonding planar substrates having an inorganic coating on the first and the second surface to planar substrates free of a coating on the first and the second surface.

It is also possible to combine both methods, especially in order to control whether the first and/or the second surface of the stack is coated or uncoated.

In one embodiment of the method according to the invention, the first and the second surface of the first substrate are uncoated, and the first and the second surface of the second substrate are coated. In other words, the method in this embodiment comprises bonding a planar substrate comprising two uncoated surfaces to a planar substrate coated on the first and the second surface to form a first stack. In embodiments in which the stack comprises more than two planar substrates, the first stack is preferably bonded to a third substrate, in which the first and the second surface are coated, to form a second stack. Alternatively, the first and the second surface of the first substrate are uncoated, and the first and the second surface of the second substrate are coated. In other words, the method in this embodiment comprises bonding a planar substrate comprising two uncoated surfaces to a planar substrate coated on the first and the second surface to form a first stack. In embodiments in which the stack comprises more than two planar substrates, the first stack is preferably bonded to a third substrate, in which the first and the second surface are coated, to form a second stack.

In one embodiment of the stack according to the invention, all the coated surfaces comprise the same inorganic coating. In another embodiment, all the coated surfaces comprise different inorganic coatings. In a further embodiment, some coated surfaces of the planar substrates comprise the same inorganic coatings and other coated surfaces of the planar substrates comprise inorganic coatings different therefrom.

Whenever mention is made herein of the same coating, this means an inorganic coating comprising substantially the same materials, comprising the same sequence of layers of materials in the same layer thickness and having the same total layer thickness.

In a further aspect, the invention relates to a stack, preferably produced or producible by the method according to the invention.

The stack produced according to the invention has a first surface and a second surface, the first and the second surface being parallel to each other. Preferably, the first and the second surface of the stack are parallel to the first and second surfaces of the respective planar substrates. The first and/or the second surface of the stack may be coated or uncoated. In some embodiments, the first and the second surface of the stack are coated, preferably with an inorganic coating. In other embodiments, the first and the second surface of the stack are uncoated. In further embodiments, the first or the second surface of the stack is coated, preferably with an inorganic coating.

Preferably, the stack according to the invention comprises 2 to 50, preferably 4 to 45, further preferably 6 to 35 or 6 to 30, particularly preferably 8 to 25 or 8 to 20 planar substrates.

In some embodiments, the thicknesses of the planar substrates in a stack may vary. Preferably, all the planar substrates have the same thickness.

In one embodiment of the method according to the invention or the stack according to the invention, the planar substrates are stacked edge-perfectly, i.e., the planar substrates are bonded to each other in such a way that the edges of all substrates are substantially flush with each other. The stack thus obtained is also referred to hereinafter as a “straight stack”.

Alternatively, the planar substrates may be stacked offset from each other, thereby yielding a “slanting stack” hereinafter. Further explanations concerning straight stacks and slanting stacks can be found in conjunction with the drawings.

In a further aspect, the invention comprises a method for producing a composite sheet, and a composite sheet, preferably for use as or in an optical waveguide element.

The composite sheet according to the invention comprises a first surface and a second surface that are parallel to each other, and at least one lateral face, and two or more planar substrates that each have a first and a second surface that are parallel to each other, the at least two planar substrates being bonded by at least one layer of adhesive.

The first and second surfaces of the planar substrates are preferably parallel to the first and the second surface of the composite sheet. The above statements concerning parallelism apply analogously here.

The explanations and preferred embodiments stated in connection with the method according to the invention apply analogously, where applicable, in connection with the composite sheet according to the invention and the following method for producing the composite sheet according to the invention.

Preferably, the method for producing a composite sheet comprises the following steps:
a) providing a stack, preferably produced or producible by the above-described method,
b) dividing the stack, preferably by cutting the stack, at least one composite sheet being obtained,
c) optionally polishing the composite sheet obtained.

In step a), a stack, preferably provided by the method of production described in detail above, is provided. If the stack comprises round planar substrates, what may be optionally carried out in a first step is trimming the round stack in such a way that an angular stack is obtained.

Step b) of the method comprises dividing the stack, preferably by cutting the stack, it being possible for said dividing to comprise multiple cutting steps, and at least one composite sheet being obtained. Depending on the cutting step, the composite sheets may have one or more lateral faces. Preferably, the composite sheet comprises one lateral face or four lateral faces. Dividing is carried out from the first to the second surface of the stack or from the second to the first surface of the stack. Naturally, the sheets obtained have the same number and sequence of layers with respect to the planar substrates, layers of adhesive and optionally inorganic coatings as the original stack and comprise the same materials as the original stack. The sheet has a first surface that was part of the first surface of the stack and a second surface that was part of the second surface of the stack. If carrying out multiple cutting steps, they are always carried out from one of the surfaces of the original stack to the other surface of the stack.

The dividing steps may be carried out in such a way that cuboidal sheets or cuboidal composite sheets are obtained. In this case, a straight stack is preferably divided, with the cutting edge being orthogonal to the first and the second surface of the stack. In this case, a so-called “straight composite sheet” is obtained. In another embodiment, the dividing steps are carried out in such a way that the cutting edge is not orthogonal to the first and the second surface, and a so-called “slanting composite sheet” is obtained. This is preferably carried out with slanting stacks and reduces scrap by minimizing unusable cuttings.

The dividing steps may be carried out in such a way that cylindrical composite sheets are obtained.

The composite sheets according to the invention are preferably used as an optical waveguide element or in an optical waveguide element.

In some embodiments, the composite sheet obtained in step b) is bonded, preferably adhesively bonded, in a further step b1) to further optical components to form a block, and the block obtained is in turn subjected to one or more dividing steps, a waveguide element being obtained. Preferably, the main surfaces of the waveguide element obtained comprise lateral faces of the composite sheet at least regionally.

Preferably, the composite sheets obtained in step b) or the waveguide elements obtained in step b1) are polished in step c).

Preferably, at least one, preferably at least two, lateral faces of the composite sheets obtained in step b) are polished. Preferably, two opposing lateral faces of the composite sheet are polished.

If the method comprises step b1), at least the regions of the main surfaces that comprise lateral faces of the composite sheet are preferably polished in step c). The following explanations in connection with the lateral faces of the composite sheets apply analogously to the regions of the main surface of the waveguide elements that have the lateral faces of the composite sheet.

In a further aspect, the invention therefore comprises a waveguide element comprising the composite sheet according to the invention. Preferably, the waveguide element has a first and a second main surface that are preferably parallel to each other, the first and/or the second main surface of the waveguide element comprising lateral faces of the composite sheet.

Polishing the lateral faces may cause the polished face to have depressions and elevations. This occurs when the stack comprises layers of varying hardness. For example, many materials suitable for the planar substrates, and typical inorganic coatings in particular, have a distinctly higher hardness than the layer of adhesive. Accordingly, the polished surfaces typically exhibit depressions, also referred to hereinafter as “dig-in”, in the case of the layer of adhesive and/or elevations in the case of substrate layers and, in particular, in the case of coating layers. Such elevations and depressions can lead to disadvantageous properties of the optical waveguide elements, since undesirable light scattering occurs thereon. Preferably, polishing with necessary observance of controlled conditions to minimize or avoid the formation of elevations and depressions is carried out in step d).

Preferably, the composite sheet according to the invention has depressions or elevations of not more than 1 μm, preferably not more than 300 nm, preferably not more than 150 nm, preferably not more than 120 nm, further preferably not more than 100 nm. Measurement is carried out, for example, with an AFM or a white light interferometer. Whenever mention is made of an elevation or a depression, it is measured from the otherwise flat lateral face of the substrates in the composite sheet (“zero line”).

Preferably, the composite sheet meets at least one of the following conditions:
viii) the first and/or the second surface of the composite sheet have a roughness R_{q} of <5 nm;
ix) the composite sheet has a TTV of less than 10 μm, based on the first and the second surface of the composite sheet;
x) the composite has a warp of <100 μm, based on the first and the second surface of the composite sheet;
xi) the composite has a bow of <100 μm, based on the first and the second surface of the composite sheet.

According to the invention, the composite comprises at least 2 and preferably not more than 100 planar substrates. In advantageous embodiments, the composite comprises 2 to 50, preferably 4 to 45, further preferably 6 to 35 or 6 to 30, particularly preferably 8 to 25 or 8 to 20, further particularly preferably from 6 to 15 planar substrates.

The invention will be described in more detail below on the basis of preferred embodiments and with reference to the accompanying drawings.

FIG. 1 schematically shows the production of a stack according to the invention.

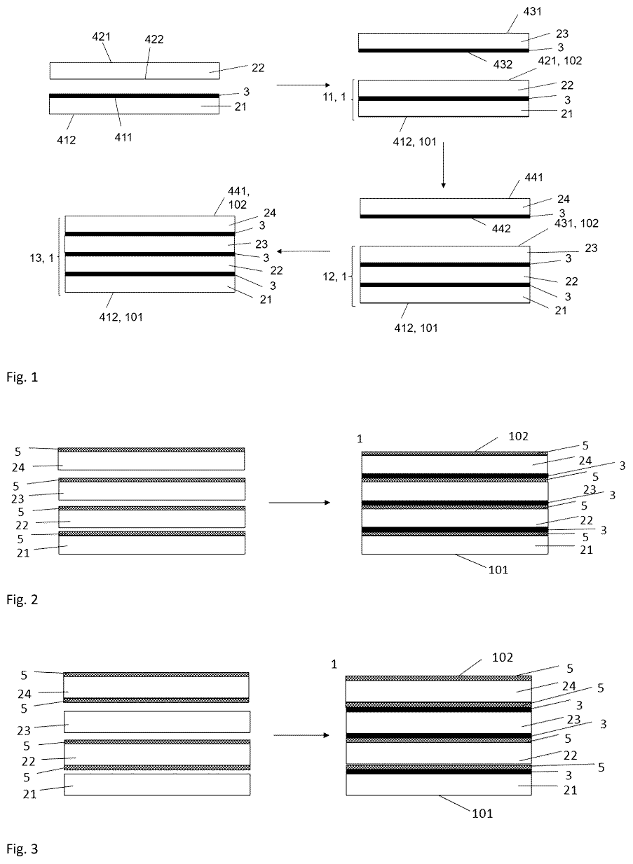

FIG. 2 shows a first embodiment of a stack containing an alternating arrangement of substrate and coating.

FIG. 3 shows a second embodiment of a stack containing an alternating arrangement of substrate and coating.

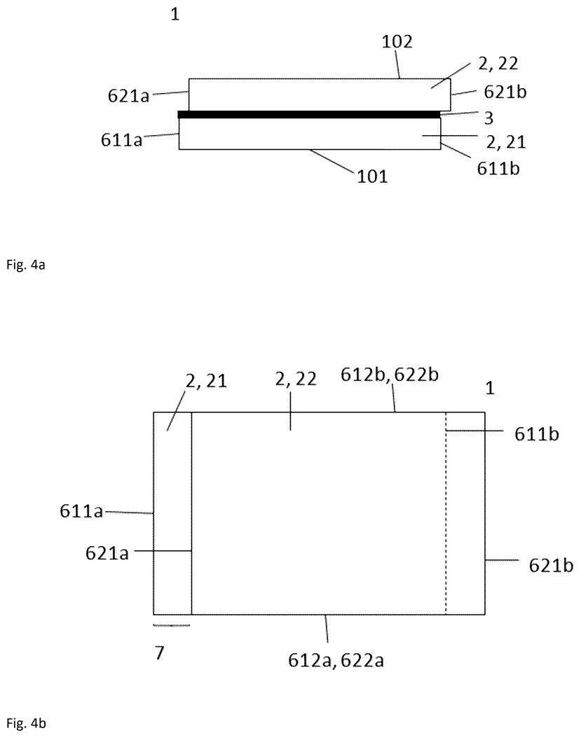

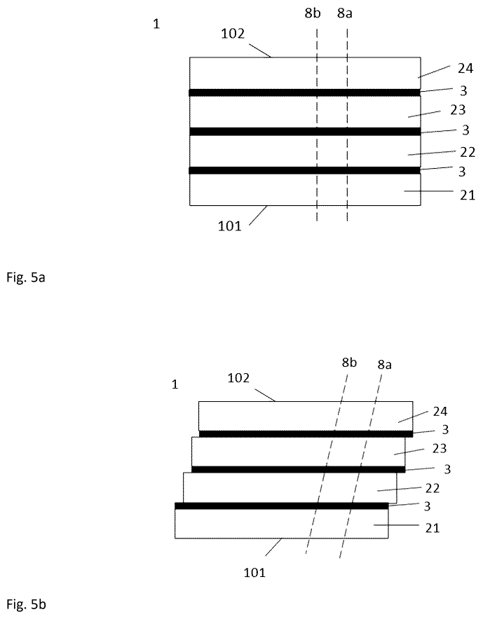

FIG. 4a and FIG. 4b show a stack in which the substrates are stacked offset from each other.

FIG. 5a and FIG. 5b schematically show the dividing of a straight stack and a slanting stack.

In the detailed description below, identical reference signs in the various embodiments refer to identical or identically acting assemblies and components. Where there are significant functional deviations, these will be explained in more detail in each case with reference to the embodiment concerned.

FIG. 1 schematically depicts the side view of one embodiment of the method according to the invention for producing a stack 1. The surfaces of the planar substrates may have an inorganic coating or may be free of a coating. For the sake of clarity, however, optional inorganic coatings are not depicted in FIG. 1. In a first step, a first planar substrate 21 comprising a first surface 411 and a second surface 412 is first provided with a layer of adhesive 3 on the first surface 411. Preferred embodiments of the method steps necessary therefor, such as cleaning, pretreatment and/or applying an adhesion promoter layer and optionally varying the viscosity of the layer of adhesive 3 by heating or cooling, have already been set forth above and apply accordingly here. The first substrate 21 comprising a layer of adhesive 3 on the first surface 411 is then contacted with and bonded, preferably over the full surface thereof, to the second surface 422 of a second substrate 22, a first stack 11 being obtained. If a stack comprising only two planar substrates is to be produced, the first stack 11 corresponds to the stack 1. Stack 11, or stack 1, has a first surface 101 corresponding to the second surface 412 of the first substrate 21 and a second surface 102 corresponding to the first surface 421 of the second substrate 22. If the first stack 11 is not the final stack 1, a further step is carried out, comprising bonding the first stack 11 to a third planar substrate 23 comprising a first surface 431 and a second surface 432 to form a second stack 12 or—if the final stack is to comprise three planar substrates—to form a stack 1. Here, the second surface 432 of the third substrate 23 is preferably provided with a layer of adhesive 3 and bonded, preferably over the full surface thereof, to the first surface 101 (not depicted) or the second surface 102 of stack 11. Alternatively, in an embodiment not depicted, the second surface 102 of the first stack 11 may be provided with a layer of adhesive 3. In order to avoid technical problems with rotation or spin coating, the layer of adhesive 3 is preferably, however, always applied to the surface of a substrate not yet bonded to another planar substrate. In a further step, the second stack 12 may be bonded to a further planar substrate 24 comprising a first surface 441 and a second surface 442 to form a further stack 13 or—if the final stack is to comprise four planar substrates—to form a stack 1. Here, the second surface 442 of the further substrate is preferably first provided with a layer of adhesive 3 and bonded, preferably over the full surface thereof, to the first surface 101 (not depicted) or the second surface 102 of stack 12. The steps described are repeated until stack 1 comprises the desired number of planar substrates.

FIG. 2 schematically shows the side view of one embodiment of the sequence of layers in stack 1. The stack 1 obtained comprises an alternating arrangement of a planar substrate 2, 21, 22, 23, 24 and an inorganic coating 5. In the embodiment depicted, this is achieved by successively bonding a first substrate 21 comprising an inorganic coating 5 on the first surface 411 to further planar substrates 22, 23, 24, each of which has an inorganic coating 5 on the first surfaces 421, 431, 441, by way of the method steps described in connection with FIG. 1. In an alternative embodiment not depicted, the stack comprises an alternating arrangement of an inorganic coating 5 and a planar substrate 2, 21, 22, 23, 24. This is achieved by successively bonding a first substrate 21 comprising an inorganic coating 5 on the second surface 412 to further planar substrates 22, 23, 24, each of which has an inorganic coating 5 on the second surfaces 422, 432, 442, by way of the method steps described above.

FIG. 3 schematically shows the side view of one embodiment of the sequence of layers in stack 1. The stack 1 obtained comprises an alternating arrangement of a planar substrate 2, 21, 22, 23, 24 and an inorganic coating 5. In the embodiment depicted, this is achieved by first bonding an uncoated first substrate 21 to a second substrate 22 comprising an inorganic coating 5 on the first surface 421 and the second surface 422 by means of a layer of adhesive 3. The first stack obtained is bonded to an uncoated third substrate by means of a layer of adhesive 3 to form a second stack, which in turn is bonded to a further substrate 24 comprising an inorganic coating 5 on the first surface 441 and the second surface 442 by means of a layer of adhesive 3. In an alternative embodiment not depicted, it is of course possible to carry out bonding of the stack 1 composed of a first substrate 21 comprising an inorganic coating 5 on the first surface 411 and the second surface 412 together with an uncoated second substrate 22, a third substrate 23 comprising an inorganic coating 5 on the first surface 431 and the second surface 432, and an uncoated fourth substrate 24.

FIG. 4a and FIG. 4b show one embodiment of the stack 1 produced according to the invention, in which the planar substrates 2 are bonded to each other with an offset such that the individual substrates 2 are not bonded to each other over the full surface thereof and a stack 1 which is also referred to hereinafter as a “slanting stack” is obtained. Preferably, the substrates 2 in such stacks are rectangular planar substrates 2. It is possible for the individual planar substrates 2 to be stacked offset in such a way that any edge of one substrate 2 does not line up with the edge of another substrate 2. Preferably, however, stacking is carried out in such a way that, in each case, two opposing edges of one substrate line up with the two opposing edges of another substrate. For the sake of clarity, FIG. 4a and FIG. 4b show a stack 1 comprising only a first substrate 21 and a second substrate 22 that are bonded to each other by means of a layer of adhesive 3. Needless to say, the slanting stack may comprise more than two planar substrates 2, for example 4 to 50 planar substrates 2. FIG. 4a and FIG. 4b show the side view and the plan view, respectively, of a stack 1 comprising a first substrate 21 and a second substrate 22. The first substrate 21 comprises two opposing edges 611a, 611b and two opposing edges 612a, 612b. The second substrate 22 comprises two opposing edges 621a, 621b and two opposing edges 622a, 622b. Preferably, the first substrate 21 and the second substrate 22 are bonded by means of a layer of adhesive 3 in such a way that the edges 611a and 611b of the first substrate do not line up with the edges 621a and 621b of the second substrate and are instead offset from each other at a distance 7 (not depicted in FIG. 4a). Further preferably, the opposing edges 612a, 612b of the first substrate 21 line up together with the opposing edges 622a, 622b of the second substrate. In some embodiments, stack 1 comprises more than two planar substrates, with preferably the distance 7 always being the same for two substrates stacked on top of each other with an offset.

FIG. 5a shows a side view of a straight stack 1 and FIG. 5b shows the side view of a slanting stack 1, each comprising four planar substrates 2, 21, 22, 23, 24 bonded to each other by means of layers of adhesive 3. The number of planar substrates 2 is merely an example; needless to say, stack 1 may also comprise more planar substrates 2, for example up to 50 planar substrates 2 or up to 30 planar substrates or up to 20 substrates 2. Preferably, the stack 1 according to the invention is further processed into sheets or optical waveguide elements, the stack 1 being subjected to one of multiple dividing steps. This is achieved by carrying out a first dividing step from the first surface of the stack 101 to the second surface 102 of the stack or, alternatively, from the second surface 102 of the stack to the first surface 101 of the stack along the dashed lines 8a and 8b, and preferably a third and a fourth dividing step at lines 8c and 8d (not depicted), a sheet or optical waveguide element being obtained. Preferably, dividing is carried out in such a way that lines 8a and 8b, and lines 8c and 8d, are parallel to each other. In the case of a straight stack 1 as shown in FIG. 5a, the dividing steps are preferably carried out in such a way that lines 8a and 8b are orthogonal to the first surface 101 and the second surface 102 of the stack 1. In embodiments in which stack 1 is a slanting stack, the dividing steps may likewise be carried out in such a way that lines 8a and 8b are orthogonal to the first surface 101 and the second surface 102 of stack 1. However, in order to minimize scrap and cuttings in the dividing procedure and thus increase the yield of sheets or optical waveguide elements from a stack 1, slanting stacks are preferably divided in such a way that lines 8a and 8b are not orthogonal to the first surface 101 and the second surface 102 of the stack 1.

### LIST OF REFERENCE SIGNS

1 stack
101 first surface of the stack
102 second surface of the stack
11 first stack
12 second stack
13 further stack
2 planar substrate
21 first planar substrate
22 second planar substrate
23 third planar substrate
24 further planar substrate
3 layer of adhesive
41 first surface of the planar substrates
42 second surface of the planar substrates
411 first surface of the first substrate
412 second surface of the first substrate
421 first surface of the second substrate
422 second surface of the second substrate
431 first surface of the third substrate
432 second surface of the third substrate
441 first surface of the further substrate
442 second surface of the further substrate
5 coating
611a, 611b opposing edges of the first substrate
612a, 612b opposing edges of the first substrate
621a, 621b opposing edges of the second substrate
622a, 622b opposing edges of the second substrate
7 distance
8a, b dividing lines

1. A method for producing a stack for further processing into composite sheets, comprising bonding two or more planar substrates with a layer of adhesive, the planar substrates each having a first and a second surface that are parallel to each other, comprising the steps of:
a) providing a first planar substrate, at least the first surface of the first planar substrate being optionally pretreated by cleaning, plasma treatment and/or applying an adhesion promoter,
b) applying an adhesive having a first viscosity to the first surface of the first substrate and rotating the first substrate, the adhesive being distributed on the first surface of the first substrate, and the resultant layer of adhesive having a layer thickness of from 0.2 μm to 5.0 μm,
c) optionally varying the viscosity of the adhesive by heating or cooling, and
d) bonding the first planar substrate to a second planar substrate to form a first stack (1, 11), comprising contacting the first surface of the first substrate with the second surface of the second substrate and curing the layer of adhesive.

2. The method of claim 1, comprising bonding the first stack to a third planar substrate, comprising the following steps:
a1) providing a third planar substrate, at least the first surface of the third planar substrate being optionally pretreated by cleaning, plasma treatment and/or applying an adhesion promoter,
b1) applying an adhesive having a first viscosity to the first surface of the third substrate and rotating the third substrate, the adhesive being distributed on the first surface of the third substrate, and the resultant layer of adhesive having a layer thickness of from 0.2 μm to 5.0 μm,
c1) optionally varying the viscosity of the adhesive by heating or cooling, and
d1) bonding the third planar substrate to the first stack, comprising contacting the first surface of the third substrate with a surface of the first stack and curing the layer of adhesive, a second stack being obtained.

3. The method of claim 2, wherein the second stack is bonded to a further planar substrate, steps a1) to d1) being repeated for this purpose, the second stack being used as first stack and a further stack being obtained.

4. The method of claim 1, wherein the stack comprises a planar substrate having an inorganic coating on the first surface and/or on the second surface.

5. The method of claim 1, wherein the stack comprises an alternating arrangement of planar substrates and inorganic coatings.

6. The method of claim 1, wherein the stack has a first surface and a second surface that are parallel to each other.

7. The method of claim 1, wherein the planar substrates are round or angular, preferably angular.

8. The method of claim 1, wherein the planar substrates are stacked edge-perfectly.

9. The method of claim 1, wherein the planar substrates are stacked offset from each other.

10. The method of claim 1, wherein stack comprises 4 to 50 planar substrates.

11. The method of claim 1, wherein the planar substrates comprise or consist of a glass, a glass ceramic, an optical ceramic or a plastic.

12. The method of claim 1, wherein the planar substrates meet at least one of the following conditions:
i) TTV of less than 10 μm;
ii) bow<100 μm;
iii) warp<100 μm; or
iv) roughness R_{q}≤5 nm.

13. The method of claim 1, wherein the layers of adhesive meet at least one of the following conditions:
i) thickness variation of less than 20 μm;
ii) no inclusions having a particle size greater than the thickness of the layer of adhesive; of iii) a refractive index which differs not more than 0.005, from the refractive index of the planar substrates.

14. The method of claim 1, wherein the adhesive has a refractive index corresponding to the refractive index of the planar substrates.

15. The method claim 1, wherein the adhesive is a light-curing adhesive.

16. A method for producing a composite sheet, comprising the following steps:
a) providing a stack, optionally produced by the method of claim 1,
b) dividing the stack, at least one composite sheet being obtained, and
c) optionally polishing the composite sheet obtained.

17. A composite sheet, comprising a first surface and a second surface that are parallel to each other, and a lateral face, and two or more planar substrates that each have a first and a second surface that are parallel to each other, the planar substrates being bonded by at least one layer of adhesive, the composite sheet preferably meeting at least one of the following conditions:
i) the first and/or the second surface of the composite sheet have a roughness R_{q} of <5 nm;
ii) the composite sheet has a TTV of less than 10 μm, based on the first and the second surface of the composite sheet;
iii) the composite has a warp of <100 μm, based on the first and the second surface of the composite sheet; or
iv) the composite has a bow of <100 μm, based on the first and the second surface of the composite sheet.

18. The composite sheet of claim 17, wherein the layers of adhesive meet at least one of the following conditions:
i) thickness variation of less than 20 μm;
ii) no inclusions having a particle size greater than the thickness of the layer of adhesive; or
iii) a refractive index which differs not more than 0.005, from the refractive index of the planar substrates.
